(19) United States
(12) Patent Application Publication
(10) Pub. No.: US 2026/0229727 A1
(43) Pub. Date: Aug. 6, 2026

(54) CELL HOLDING APPARATUS

(71) Applicant: HONDA MOTOR CO., LTD., Tokyo (JP)

(72) Inventor: Hideaki Sasaki, Wako-shi (JP)

(21) Appl. No.: 19/441,907

(22) Filed: Jan. 7, 2026

(30) Foreign Application Priority Data
Feb. 5, 2025 (JP) 2025-017531

(51) Int. Cl. H01M 50/536; H01M 10/0585; H01M 50/54

(52) U.S. Cl. CPC H01M 50/536; H01M 10/0585; H01M 50/54

(57) ABSTRACT

A cell holding apparatus is used for manufacturing a solid-state battery cell that includes: an electrode assembly body in which a positive electrode and a negative electrode are alternately laminated via a solid electrolyte; and a laminate film which covers the electrode assembly body, the cell holding apparatus including: a current collector foil regulation tool that guides a current collector foil which protrudes from the electrode assembly body; and a cell regulation tool that holds the electrode assembly body in conjunction with the current collector foil regulation tool.

### CROSS-REFERENCE TO RELATED APPLICATION

Priority is claimed on Japanese Patent Application No. 2025-017531, filed on February 5, 2025, the contents of which are incorporated herein by reference.

### BACKGROUND

### Field of the Invention

The present invention relates to a cell holding apparatus.

### Background

An all-solid-state battery includes an electrode assembly body in which a positive electrode and a negative electrode are alternately laminated via a solid electrolyte and a current collector foil that protrudes from the electrode assembly body. The all-solid-state battery expands in a lamination direction of the electrode assembly body.

Therefore, an extra length is formed in the current collector foil such that the current collector foil is not stretched by the expansion of the all-solid-state battery and is not broken. In order to form the extra length in the current collector foil, the electrode assembly body is sealed by a laminate film in a state where the current collector foil is pushed to an electrode assembly body side by 2 mm along a perpendicular direction to the lamination direction of the electrode assembly body.

The following problems arise when forming the extra length in the current collector foil.

Since the rigidity of the current collector foil of the positive electrode is different from that of the current collector foil of the negative electrode, an electrode group including the positive electrode and the negative electrode is displaced when pushing the current collector foil to the electrode assembly body side.

When pushing the current collector foil, due to the rigidity of the current collector foil, the electrode group protrudes to the outermost surface side in the lamination direction of the electrode assembly body, and the laminate film that covers an end portion of the electrode assembly body is broken.

Although it is important that the position of the middle of the current collector foil is matched with the position of the middle of the electrode group, due to the gravity force, the electrode assembly body is sealed by the laminate film in a state where the position of the middle of the current collector foil is displaced from the position of the middle of the electrode group.

As a method of solving the problems as described above, for example, it is known to provide a guide for lowering a tensile force of the current collector foil that protrudes from the electrode assembly body (for example, refer to Published Japanese Translation No. 2023-521810 of the PCT International Publication).

### SUMMARY

An aspect of the present invention aims at providing a cell holding apparatus that can improve a manufacturing accuracy of a solid-state battery cell and contributes to the stabilization of battery performances and the improvement of energy efficiency.

A first aspect of the present invention is a cell holding apparatus used for manufacturing a solid-state battery cell that includes: an electrode assembly body in which a positive electrode and a negative electrode are alternately laminated via a solid electrolyte; and a laminate film which covers the electrode assembly body, the cell holding apparatus including: a current collector foil regulation tool that guides a current collector foil which protrudes from the electrode assembly body; and a cell regulation tool that holds the electrode assembly body in conjunction with the current collector foil regulation tool.

According to the first aspect described above, by guiding the current collector foil, and at the same time, by holding the electrode assembly body and also defining the position of the electrode assembly body, it is possible to improve a manufacturing accuracy of the solid-state battery cell.

A second aspect is the cell holding apparatus according to the first aspect described above, wherein the current collector foil regulation tool may be movable along a lamination direction of the positive electrode and the negative electrode in the electrode assembly body, and the cell regulation tool may be movable along the lamination direction of the positive electrode and the negative electrode in the electrode assembly body in accordance with a movement of the current collector foil regulation tool.

According to the second aspect described above, the current collector foil regulation tool and the cell regulation tool move simultaneously, and thereby, when the solid-state battery cell is lowered downward in the lamination direction of the positive electrode and the negative electrode in the electrode assembly body by the own weight of the solid-state battery cell, it is possible to arrange the solid-state battery cell at an appropriate position between the two holding tools.

A third aspect is the cell holding apparatus according to the first aspect described above which may further include: a tab lead push tool, wherein the tab lead push tool may be movable along a perpendicular direction to a lamination direction of the positive electrode and the negative electrode in the electrode assembly body and may push the current collector foil in an electrode assembly body side along the perpendicular direction and form an extra length in the current collector foil.

According to the third aspect described above, it is possible to push the current collector foil to the electrode assembly body side and form an extra length in the current collector foil.

A fourth aspect is the cell holding apparatus according to the third aspect described above, wherein the current collector foil regulation tool may offset a position where the current collector foil is bundled in the lamination direction.

According to the fourth aspect described above, it is possible to prevent a step having a crank shape from occurring in the current collector foil.

A fifth aspect is the cell holding apparatus according to the first aspect described above which may include: a tool that is arranged at a middle of the current collector foil and forms an extra length in the current collector foil before sealing the laminate film.

According to the fifth aspect described above, it is possible to expand the middle of the current collector foil and form the extra length in the current collector foil before sealing the laminate film.

A sixth aspect is the cell holding apparatus according to the fifth aspect described above, wherein the tool may be a wide plate and may be rotated by 90 degrees with respect to a bundle direction of the current collector foil.

According to the sixth aspect described above, it is possible to form the extra length in the current collector foil.

A seventh aspect is the cell holding apparatus according to the fifth aspect described above which may further include: a tab lead push tool, wherein the tab lead push tool may be movable along a perpendicular direction to a lamination direction of the positive electrode and the negative electrode in the electrode assembly body and may push the current collector foil in an electrode assembly body side along the perpendicular direction and form an extra length in the current collector foil, and the tab lead push tool may insert the current collector foil toward a position where the tool has been present.

According to the seventh aspect described above, it is possible to form the extra length of the current collector foil in a shape that is curved and spaced apart from a middle line in the lamination direction of the electrode assembly body and prevent the current collector foil from being broken by a force from the outside.

According to the aspect of the present invention, it is possible to provide a cell holding apparatus capable of improving a manufacturing accuracy of a solid-state battery cell.

### BRIEF DESCRIPTION OF THE DRAWINGS

FIG. 1 is a cross-sectional view showing a cell holding apparatus according to an embodiment of the present invention.

FIG. 2 is a cross-sectional view showing the cell holding apparatus according to the embodiment of the present invention.

### DESCRIPTION OF EMBODIMENTS

Hereinafter, an embodiment of the present invention will be described in detail with reference to the drawings.

### Cell Holding Apparatus

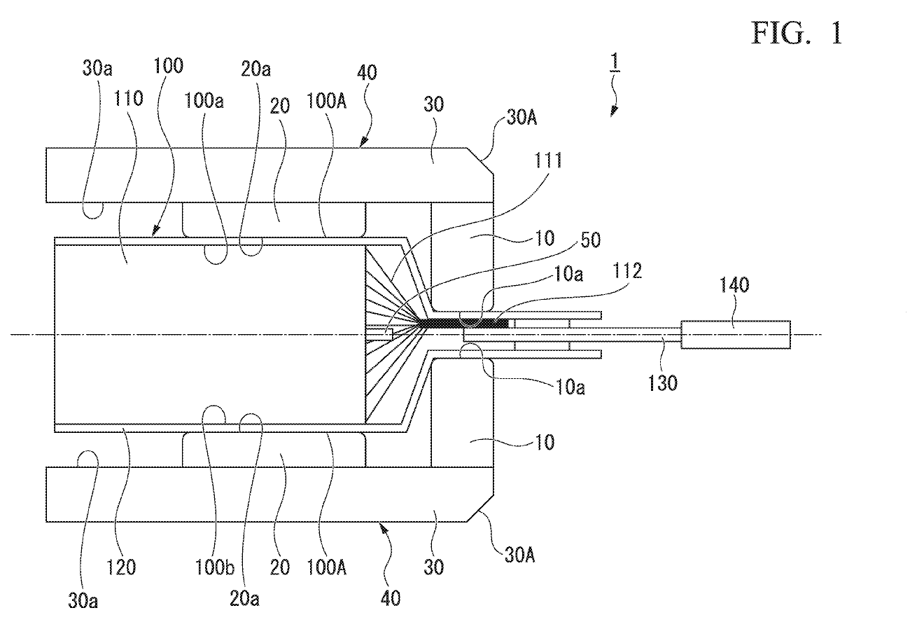

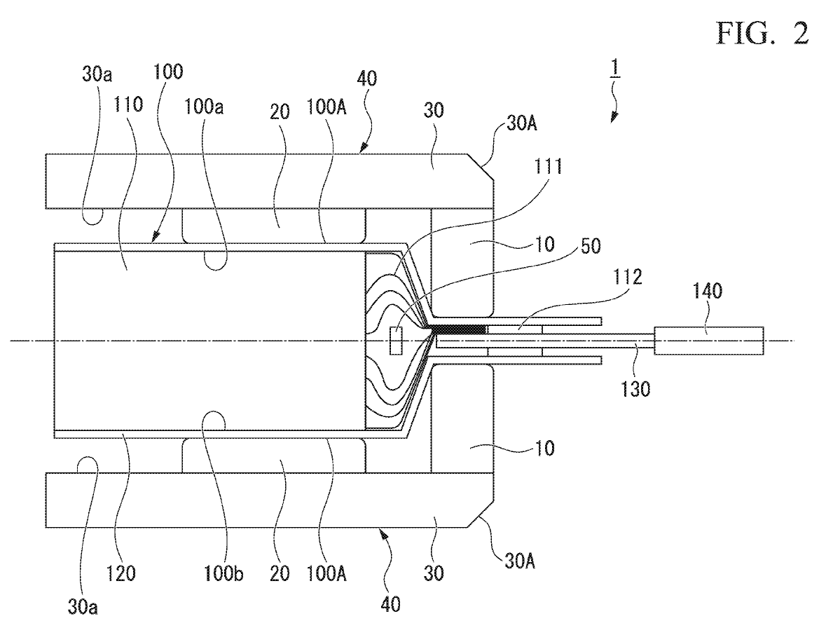

FIG. 1 and FIG. 2 are sectional views showing a cell holding apparatus according to an embodiment of the present invention. In the drawings used in the following description, in order to make characteristics easy to understand, characteristic portions may be shown in an enlarged manner for the sake of convenience, and dimensional ratios or the like of each constituent element are not limited to exemplary examples.

As shown in FIG. 1, a cell holding apparatus 1 of the present embodiment includes a current collector foil regulation tool 10 and a cell regulation tool 20. The current collector foil regulation tool 10 and the cell regulation tool 20 are provided on one main surface 30a of a base body 30. More specifically, the cell holding apparatus 1 includes two (a pair of) holding tools 40 each of which includes the current collector foil regulation tool 10, the cell regulation tool 20, and the base body 30.

The cell holding apparatus 1 of the present embodiment is used for manufacturing a solid-state battery cell 100 that includes: an electrode assembly body 110 in which a positive electrode and a negative electrode are alternately laminated via a solid electrolyte; and a laminate film 120 which covers the electrode assembly body 110. The holding tool 40 holds the solid-state battery cell 100 so as to sandwich the solid-state battery cell 100 from both sides (sides of an outermost surface 100a of the solid-state battery cell 100 and an outermost surface 100b of the solid-state battery cell 100) in a lamination direction of a positive electrode and a negative electrode in the electrode assembly body 110. More specifically, the two holding tools 40 hold the solid-state battery cell 100 such that surfaces 10a, which are in contact with the solid-state battery cell 100 (laminate film 120), of the current collector foil regulation tools 10 of the two holding tools 40 face each other and such that surfaces 20a, which are in contact with the solid-state battery cell 100 (laminate film 120), of the cell regulation tools 20 of the two holding tools 40 face each other.

The current collector foil regulation tool 10 guides a current collector foil 111 that protrudes from the electrode assembly body 110. The current collector foil regulation tool 10 is provided on one end portion 30A in a direction along the outermost surfaces 100a and 100b of the solid-state battery cell 100 in the base body 30 and is perpendicular to the one main surface 30a of the base body 30. That is, the current collector foil regulation tool 10 is provided so as to protrude in a perpendicular direction to the one main surface 30a of the base body 30 from the one main surface 30a of the base body 30.

The cell regulation tool 20 holds the electrode assembly body 110. The cell regulation tool 20 is provided on the one main surface 30a of the base body 30 at a position that faces an edge portion 100A of the solid-state battery cell 100 and is spaced apart from the current collector foil regulation tool 10. Further, the cell regulation tool 20 is provided to be perpendicular to the one main surface 30a of the base body 30. That is, the cell regulation tool 20 is provided so as to protrude in a perpendicular direction to the one main surface 30a of the base body 30 from the one main surface 30a of the base body 30. The cell regulation tool 20 can hold the electrode assembly body 110 such that the electrode assembly body 110 is not displaced and does not move when a tab lead is pushed to an electrode assembly body 110 side by a tab lead push tool 140.

A set position of the cell regulation tool 20 can preferably be a position close to the current collector foil 111 in order to prevent the electrode assembly body 110 from being displaced when a tab lead 130 is pushed. Further, since a restraining load is applied to a local portion of the electrode assembly body 110 when an area where the cell regulation tool 20 and the solid-state battery cell 100 are in contact with each other is too small, and a breakage of the electrode assembly body 110 occurs, the area can be preferably 10% or more of the total area of each of the outermost surfaces 100a and 100b of the solid-state battery cell 100.

As described above, the current collector foil regulation tool 10 and the cell regulation tool 20 are provided on the base body 30. Accordingly, the current collector foil regulation tool 10 and the cell regulation tool 20 are interlocked and hold the solid- state battery cell 100 (electrode assembly body 110). More specifically, when the holding tool 40 is moved in the lamination direction of the positive electrode and the negative electrode in the electrode assembly body 110, the current collector foil regulation tool 10 and the cell regulation tool 20 simultaneously move in the lamination direction of the positive electrode and the negative electrode in the electrode assembly body 110.

The length of the current collector foil regulation tool 10 and the length of the cell regulation tool 20 are set with reference to the one main surface 30a of the base body 30 such that, when the holding tool 40 is moved in the lamination direction of the positive electrode and the negative electrode in the electrode assembly body 110, the current collector foil regulation tool 10 holds the current collector foil 111, and at the same time, the cell regulation tool 20 holds the solid-state battery cell 100.

The solid-state battery cell 100 includes the electrode assembly body 110 and the laminate film 120. The laminate film 120 covers an outer surface of the electrode assembly body 110 and accommodates the electrode assembly body 110. Further, the electrode assembly body 110 has the current collector foil 111 that protrudes from the electrode assembly body 110. The current collector foil 111 is bundled at an end portion on the opposite side of the electrode assembly body 110 and forms a bundle portion 112. The bundle portion 112 is connected to the tab lead 130.

The electrode assembly body 110 has a positive electrode, a negative electrode, and a solid electrolyte layer.

### Positive Electrode

The positive electrode is constituted by laminating a first current collector foil and a first active material layer including at least a positive electrode active material. The first current collector foil is the current collector foil 111.

The first current collector foil can be preferably constituted of at least one material having a high conductivity.

Examples of the material having a high conductivity include a metal or an alloy containing at least one of metal elements such as silver (Ag), palladium (Pd), gold (Au), platinum (Pt), aluminum (Al), chromium (Cr), and nickel (Ni), or a non-metal such as carbon (C). In consideration of manufacturing costs in addition to the high conductivity, aluminum, nickel, or stainless steel can be preferably used. Further, aluminum is unlikely to react with the positive electrode active material and an electrolyte. Therefore, when aluminum is used for the first current collector foil, the internal resistance of the battery can be reduced.

Examples of forms of the first current collector foil can include a foil form, a plate form, a mesh form, a non-woven fabric form, a foam form, and the like. Further, in order to enhance adhesion to the first active material layer, carbon or the like may be arranged on a surface of the first current collector foil, or the surface may be coarsened.

The first active material layer includes a positive electrode active material that exchanges lithium ions and electrons. The positive electrode active material is not particularly limited as long as the positive electrode active material is a material capable of reversibly releasing and absorbing lithium ions and transferring electrons, and a known positive electrode active material that is applicable to a positive electrode of a lithium-ion battery can be used. Examples of the positive electrode active material include: composite oxides such as lithium cobalt oxide (LiCoO₂), lithium nickel oxide (LiNiO₂), lithium manganese oxide (LiMn₂O₄), solid solution oxides (Li₂MnO₃-LiMO₂ (M=Co, Ni, or the like)), lithium-manganese-nickel-cobalt oxide (LiNiₓMn_{y}Co_{z}O₂, x+y+z=1), and olivine-type lithium phosphate oxide (LiFePO₄); conductive polymers such as polyaniline and polypyrrole; sulfides such as Li₂S, CuS, Li-Cu-S compounds,

TiS₂, FeS, MoS₂, and Li-Mo-S compounds; mixtures of sulfur and carbon; and the like. The positive electrode active material may be constituted of one kind of the above materials alone or may be constituted of two or more kinds thereof.

The first active material layer includes an electrolyte that exchanges lithium ions with the positive electrode active material. The electrolyte is not particularly limited as long as the electrolyte has lithium-ion conductivity, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer-based solid electrolytes such as polyethylene oxide, gel-based solid electrolytes containing lithium-containing salts or lithium-ion conductive ionic liquids, and the like.

Among these, sulfide solid electrolyte materials can be preferable from the viewpoint of high conductivity properties of lithium ions, favorable structural formability by pressing, and favorable interfacial bonding properties.

The electrolyte may be constituted of one kind of the above materials alone or may be constituted of two or more kinds thereof.

The electrolyte included in the first active material layer may be the same material as or may be a material different from the electrolyte included in a second active material layer and the solid electrolyte layer.

The first active material layer may contain a conductive additive from the viewpoint of improvement in conductivity of the positive electrode. As the conductive additive, a conductive additive which can be generally used for a lithium-ion battery can be used.

Examples of the conductive additive can include: carbon black such as acetylene black or Ketjen black; carbon fibers; vapor grown carbon fibers; graphite powder; and carbon materials such as carbon nanotubes. The conductive additive may be constituted of one kind of the above materials alone or may be constituted of two or more kinds thereof.

Further, the first active material layer may contain a binder that plays a role in binding the positive electrode active materials to each other, and the positive electrode active material and the first current collector foil to each other.

The first current collector foil is bundled at one end portion in a width direction of the all-solid-state battery.

The first active material layer is in contact with the solid electrolyte layer and may therefore contain sulfides contained in the solid electrolyte layer.

### Negative Electrode

The negative electrode is constituted by laminating a second current collector foil and a second active material layer including at least a negative electrode active material. The second current collector foil is the current collector foil 111.

The second current collector foil contains at least copper (Cu). Similarly to the first current collector foil, the second current collector foil may contain a material other than copper having a high conductivity. Examples of the material other than copper having a high conductivity include a metal or an alloy containing at least one of metal elements such as silver (Ag), palladium (Pd), gold (Au), platinum (Pt), chromium (Cr), and nickel (Ni), or a non-metal such as carbon (C). In consideration of manufacturing costs in addition to the high conductivity, nickel or stainless steel can be preferably used as the material other than copper. Further, stainless steel is unlikely to react with the positive electrode active material, the negative electrode active material, and the electrolyte. Therefore, when stainless steel is used for the second current collector foil, the manufacturing costs of the battery can be reduced.

Examples of forms of the second current collector foil can include a foil form, a plate form, a mesh form, a non-woven fabric form, a foam form, and the like. Further, in order to enhance adhesion to the second active material layer, carbon or the like may be arranged on a surface of the second current collector foil, or the surface may be coarsened.

The second active material layer includes the negative electrode active material that exchanges lithium ions and electrons. The negative electrode active material is not particularly limited as long as the negative electrode active material is a material capable of reversibly releasing and absorbing lithium ions and transferring electrons, and a known negative electrode active material that is applicable to a negative electrode of a lithium-ion battery can be used. Examples of the negative electrode active material include: carbonaceous materials such as natural graphite, artificial graphite, resin charcoal, carbon fibers, activated charcoal, hard carbon, and soft carbon; alloy-based materials mainly consisting of tin, a tin alloy, silicon, a silicon alloy, gallium, a gallium alloy, indium, an indium alloy, aluminum, an aluminum alloy, and the like; conductive polymers such as polyacene, polyacetylene, and polypyrrole; metallic lithium; and lithium alloys such as lithium-titanium composite oxides (for example, Li₄Ti₅O₁₂). These negative electrode active materials may be constituted of one kind of the above materials alone or may be constituted of two or more kinds thereof.

The second active material layer includes an electrolyte that exchanges lithium ions with the negative electrode active material. The electrolyte is not particularly limited as long as the electrolyte has lithium-ion conductivity, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer- based solid electrolytes such as polyethylene oxide, gel-based solid electrolytes containing lithium-containing salts or lithium-ion conductive ionic liquids, and the like. The electrolyte may be constituted of one kind of the above materials alone or may be constituted of two or more kinds thereof.

The electrolyte included in the second active material layer may be similar to or different from the electrolyte included in the first active material layer and the solid electrolyte layer.

The second active material layer may contain a conductive additive, a binder, and the like. These materials are not particularly limited, but, for example, materials similar to those used for the first active material layer described above can be used.

### Solid Electrolyte Layer

The solid electrolyte layer is arranged between the first active material layer and the second active material layer.

The electrolyte is not particularly limited as long as the electrolyte has lithium-ion conductivity and insulation properties, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer-based solid electrolytes such as polyethylene oxide, gel-based electrolytes containing lithium-containing salts or lithium-ion conductive ionic liquids, and the like. Among these, sulfide solid electrolyte materials are preferable from the viewpoint of high conductivity properties of lithium ions, favorable structural formability by pressing, and favorable interfacial bonding properties.

The form of the electrolyte materials is not particularly limited, but examples of the form can include particles.

The solid electrolyte layer may contain an adhesive for imparting mechanical strength and flexibility.

The solid electrolyte layer may have a sheet shape having a porous substrate and a solid electrolyte held in the porous substrate. The form of the porous substrate described above is not particularly limited, but examples of the form include woven fabric, non-woven fabric, mesh cloth, a porous film, an expanded sheet, a punching sheet, and the like. Among these forms, non-woven fabric can be preferable from the viewpoint of handleability in which the filling amount of a solid electrolyte can be enhanced.

The porous substrate described above can be preferably constituted of an insulating material. Thereby, insulation properties of the solid electrolyte layer can be improved. Examples of the insulating material include: resin materials such as nylon, polyester, polyethylene, polypropylene, polytetrafluoroethylene, an ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, and an acrylic resin; natural fibers such as hemp, wood pulp, and cotton lint; glass; and the like.

### Laminate Film

The laminate film 120 is a laminate film having an inner resin layer, a metal layer, and an outer resin layer. Examples of the resin that constitutes the inner resin layer and the outer resin layer include polyester resins such as polyethylene terephthalate (PET). The metal layer is constituted of, for example, an aluminum foil or the like.

The current collector foil regulation tool 10 is movable along a lamination direction of the positive electrode and the negative electrode in the electrode assembly body 110. Further, the cell regulation tool 20 is movable along the lamination direction of the positive electrode and the negative electrode in the electrode assembly body 110 in accordance with the movement of the current collector foil regulation tool 10. In this way, the current collector foil regulation tool 10 and the cell regulation tool 20 move simultaneously, and thereby, when the solid-state battery cell 100 is lowered downward in the lamination direction by the own weight of the solid-state battery cell 100, it is possible to arrange the solid-state battery cell 100 at an appropriate position between the two holding tools 40.

The tab lead push tool 140 is movable along a perpendicular direction to the lamination direction of the positive electrode and the negative electrode in the electrode assembly body 110. Further, the tab lead push tool 140 pushes the current collector foil 111 in an electrode assembly body 110 side along the perpendicular direction and forms an extra length in the current collector foil 111.

The current collector foil regulation tool 10 offsets a position (bundle portion 112) where the current collector foil 111 is bundled in the lamination direction of the positive electrode and the negative electrode in the electrode assembly body 110. The offset amount can be preferably (1/2 of the thickness of the tab lead 130) + (1/2 of the thickness of the bundle portion 112). Thereby, it is possible to prevent a crank shape from occurring in the current collector foil 111.

The cell holding apparatus 1 of the present embodiment may include a tool 50 that is arranged at a middle of a plurality of current collector foils 111 and forms an extra length in the current collector foil 111 before sealing the laminate film 120. Thereby, it is possible to expand the middle of the current collector foil 111 and form the extra length in the current collector foil 111 before sealing the laminate film 120.

The tool 50 is a wide plate and is rotated by 90 degrees with respect to a bundle direction of the current collector foil 111. Thereby, the state in which the extra length is not formed in the current collector foil 111 shown in FIG. 1 can be changed to the state in which the extra length is formed in the current collector foil 111 shown in FIG. 2.

The tab lead push tool 140 inserts the current collector foil 111 toward a position where the tool 50 has been present. Thereby, it is possible to form the extra length of the current collector foil 111 in a shape that is curved and spaced apart from a middle line in the lamination direction of the electrode assembly body 110 as shown in FIG. 2 and prevent the current collector foil 111 from being broken by a force from the outside.

According to the cell holding apparatus 1 of the present embodiment, by guiding the current collector foil 111, and at the same time, by holding the electrode assembly body 110 and also defining the position of the electrode assembly body 110, it is possible to improve manufacturing accuracy with respect to the solid-state battery cell 100.

Although the embodiment of the present invention has been described in detail, the present invention is not limited to the embodiment described above, and various modifications and changes can be made within the scope of the gist of the present invention described in the claims.

What is claimed is:

1. A cell holding apparatus used for manufacturing a solid-state battery cell having an electrode assembly body in which a positive electrode and a negative electrode are alternately laminated via a solid electrolyte and a laminate film which covers the electrode assembly body, the cell holding apparatus comprising:
a current collector foil regulation tool that guides a current collector foil which protrudes from the electrode assembly body; and
a cell regulation tool that holds the electrode assembly body in conjunction with the current collector foil regulation tool.

2. The cell holding apparatus according to claim 1,
wherein the current collector foil regulation tool is movable along a lamination direction of the positive electrode and the negative electrode in the electrode assembly body, and
the cell regulation tool is movable along the lamination direction of the positive electrode and the negative electrode in the electrode assembly body in accordance with a movement of the current collector foil regulation tool.

3. The cell holding apparatus according to claim 1, further comprising:
a tab lead push tool,
wherein the tab lead push tool is movable along a perpendicular direction to a lamination direction of the positive electrode and the negative electrode in the electrode assembly body and pushes the current collector foil to an electrode assembly body side along the perpendicular direction and forms an extra length in the current collector foil.

4. The cell holding apparatus according to claim 3,
wherein the current collector foil regulation tool offsets a position where the current collector foil is bundled in the lamination direction.

5. The cell holding apparatus according to claim 1, comprising:
a tool that is arranged at a middle of the current collector foil and forms an extra length in the current collector foil before sealing the laminate film.

6. The cell holding apparatus according to claim 5,
wherein the tool is a wide plate and is rotated by 90 degrees with respect to a bundle direction of the current collector foil.

7. The cell holding apparatus according to claim 5, further comprising:
a tab lead push tool,
wherein the tab lead push tool is movable along a perpendicular direction to a lamination direction of the positive electrode and the negative electrode in the electrode assembly body and pushes the current collector foil to an electrode assembly body side along the perpendicular direction and forms an extra length in the current collector foil, and the tab lead push tool inserts the current collector foil toward a position where the tool has been present.
